(19) United States
(12) Patent Application Publication
(10) Pub. No.: US 2015/0285164 A1
(43) Pub. Date: Oct. 8, 2015

(54) Fuel System for an Internal Combustion Engine which can be Operated with at least Two Fuel Types

(71) Applicant: Robert Bosch GmbH, Stuttgart (DE)

(72) Inventors: Alexander Gluschke, Schwieberdingen (DE); Frank Nitsche, Remseck Am Neckar (DE); Martin Maier, Moeglingen (DE); Winfried Langer, Illingen (DE); Peter Schenk, Ludwigsburg (DE); Thorsten Allgeier, Untergruppenbach (DE); Henri Barbier, Bangalore (IN)

(21) Appl. No.: 14/361,398

(22) PCT Filed: Oct. 18, 2012
(86) PCT No.: PCT/EP2012/070625

§ 371 Date: May 29, 2014

(30) Foreign Application Priority Data
Dec. 16, 2011 (DE) 10 2011 088 795.4

(51) Int. Cl. F02D 19/06; F02M 21/02; F02M 43/02

(52) U.S. Cl. CPC F02D 19/0647; F02M 43/02; F02M 21/0245; F02M 21/0242; F02M 21/0203; F02D 19/0681

(57) ABSTRACT

A fuel system for an internal combustion engine is configured to operate with at least two fuel types, and includes an electrically driven high-pressure fuel pump for at least one of the two fuel types. The high-pressure fuel pump is connected on an outlet side to a high-pressure line which is common to the two fuel types.

### PRIOR ART

The invention relates to a fuel system according to the preamble of claim 1.

Internal combustion engines, in particular of motor vehicles, which can be operated alternatively and in a switchable fashion with gasoline or liquefied petroleum gas (LPG), are known from the market. As a result, a motor vehicle can be driven flexibly and in a particularly environmentally friendly way.

### DISCLOSURE OF THE INVENTION

The problem on which the invention is based is solved by a fuel system as claimed in claim 1. Advantageous developments are specified in dependent claims. Features which are important for the invention can also be found in the following description and in the drawings, wherein the features can be important for the invention either alone or in different combinations without this being explicitly indicated once more.

The invention has the advantage that a fuel system of an internal combustion engine can be operated with two fuel types, wherein filling losses can be avoided by means of direct injection of liquefied petroleum gas. Likewise, an undesired reduction in power can be avoided. Coking of, for example, injection valves for the direct injection of gasoline can be at least reduced. Furthermore, the fuel system according to the invention makes a particularly good cold starting capability possible. The injection system of the internal combustion engine can be manufactured particularly easily and cost-effectively, wherein just one type of injection valve and just one high-pressure accumulator (“rail”) are necessary. An electrically driven high-pressure fuel pump can be arranged spatially distant from the internal combustion engine in or on a fuel container (tank), as a result of which the temperature of the fuel pump can be low and a predelivery pressure can be particularly low. The predelivery pressure can easily be generated by means of a conventional electrically driven fuel pump. The temperature of the fuels in the tank can also be kept comparatively low. The production of gas bubbles and deposition of paraffin can be reduced or avoided and the service life of the high-pressure fuel pump can therefore be maintained. Furthermore, the fuel system according to the invention permits the internal combustion engine also to start with liquefied petroleum gas in a cold or hot state.

The invention relates to a fuel system for an internal combustion engine which can be operated in a switchable fashion with at least two fuel types. In particular, the fuel system comprises an electrically driven high-pressure fuel pump for at least one of the two fuel types. On the outlet side, the electrically driven high-pressure fuel pump is connected to a high-pressure line which is common to the two fuel types. A fuel high-pressure accumulator for supplying injection valves of the internal combustion engine is connected downstream of the high-pressure line. The same injection valves are used for the two fuel types, as a result of which costs are also eliminated and the complexity of the internal combustion engine is reduced.

In particular, the invention provides that a first fuel type is gasoline or diesel fuel or some other fuel with a comparatively low vapor pressure and a second fuel type is liquefied petroleum gas or some other fuel with a comparatively high vapor pressure. As a result, the fuel system can be operated with fuels which are particularly suitable for operating the internal combustion engine and which are commercially available virtually everywhere.

The invention operates particularly well if the electrically driven high-pressure fuel pump is thermally insulated and/or arranged separately from the internal combustion engine. This avoids the high-pressure fuel pump being heated by the operating heat of the internal combustion engine. In accordance with the comparatively low increase in temperature of the fuel on the way from the fuel container to the high-pressure fuel pump, it is also possible to prevent vaporization or gas bubbles even at a relatively low hydraulic pressure, and therefore avoid disruption during the operating of the fuel system.

A first refinement of the fuel system provides that said fuel system comprises a first mechanically driven high-pressure fuel pump for feeding gasoline and a second electrically driven high-pressure fuel pump for feeding liquefied petroleum gas, which high-pressure fuel pumps are connected on the outlet side to the common high-pressure line. As a result, essential elements of a conventional fuel system are used, which can simplify the design. The mechanically driven high-pressure fuel pump comprises, for example, a quantity control valve.

In addition to this there is provision that an electrically driven fuel pump is arranged in a region of a fuel container for the respective fuel type, and that a pressure region of the electrically driven fuel pump for feeding gasoline is connected to a suction region of the mechanically driven high-pressure fuel pump, and that a pressure region of the electrically driven fuel pump for feeding liquefied petroleum gas can be connected to a suction region of the electrically driven high-pressure fuel pump. Because of the low predelivery pressure according to the invention it is possible to use conventional electrically driven fuel pumps which are preferably arranged in or on the respective tank. This eliminates costs.

There is also additionally provision that a non-return valve is arranged in a pressure region of the mechanically driven high-pressure fuel pump, wherein the non-return valve can open in the feed direction, and that a check valve or also a non-return valve is arranged in the pressure region of the electrically driven fuel pump for feeding liquefied petroleum gas. This prevents the two fuel types being mixed with one another. The non-return valve can also be embodied as a switching valve.

A second refinement of the fuel system provides that the electrically driven high-pressure fuel pump can be connected on the inlet side both to gasoline and to liquefied petroleum gas and is connected on the outlet side to the high-pressure line. As a result, the mechanically driven high-pressure fuel pumps can be eliminated and costs can be reduced.

In addition to this there is provision that an electrically driven fuel pump is arranged in a region of a fuel container for the respective fuel type, wherein a pressure region of the electrically driven fuel pump for feeding gasoline can be connected to a suction region of the electrically driven high-pressure fuel pump, and wherein a pressure region of the electrically driven fuel pump for feeding liquefied petroleum gas can also be connected to the suction region of the electrically driven high-pressure fuel pump. As a result, cost-effective, conventional electrically driven fuel pumps can also be used for generating the respective predelivery pressure for the second refinement of the invention.

There is also additionally provision that a non-return valve is arranged in the pressure region of the electrically driven fuel pump for feeding gasoline, wherein the non-return valve can open in the feed direction, and that a check valve or a non-return valve is arranged in the pressure region of the electrically driven fuel pump for feeding liquefied petroleum gas.

As a result, the two fuel types are also prevented from mixing with one another here. The check valve or the non-return valve can also be embodied as a switching valve.

A third refinement of the fuel system provides that an electrically driven fuel pump is arranged in a region of a fuel container for gasoline, and that the electrically driven high-pressure fuel pump is arranged in a region of a fuel container for liquefied petroleum gas, and that a pressure region of the electrically driven fuel pump can be connected to a suction region of the electrically driven high-pressure fuel pump. Therefore, a particularly compact fuel system is described which in many cases requires only a total of two fuel pumps. Under certain circumstances, a predelivery pressure can be generated by means of an optional electrically driven fuel pump in the liquefied petroleum gas mode in order to assist the electrically driven high-pressure fuel pump.

In addition to this there is provision that a non-return valve is arranged in the pressure region of the electrically driven fuel pump for feeding gasoline, wherein the non-return valve can open in the feed direction, and that the fuel container for liquefied petroleum gas is connected to the suction region of the electrically driven high-pressure fuel pump via a switching valve or a non-return valve. As a result, the two fuel types are also prevented from mixing with one another here. The switching valve or the non-return valve can be arranged upstream or downstream of the electrically driven high-pressure fuel pump.

Exemplary embodiments of the invention are explained below with reference to the drawing, in which:

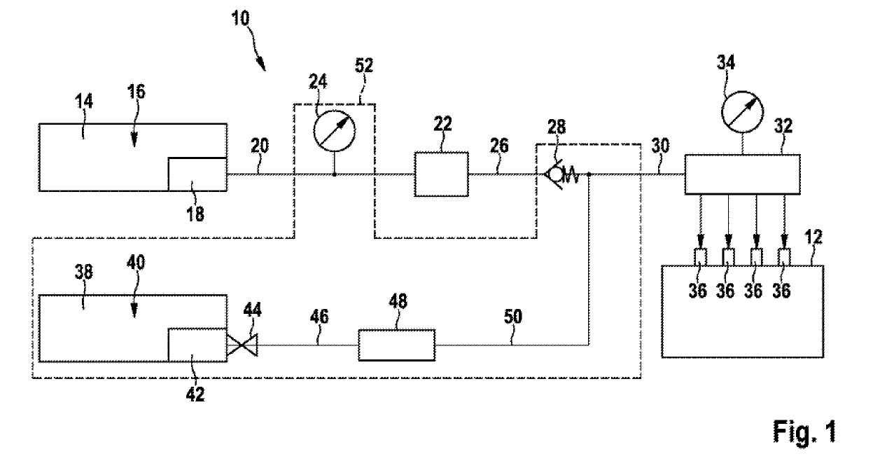

FIG. 1 shows a fuel system for an internal combustion engine in a first embodiment;

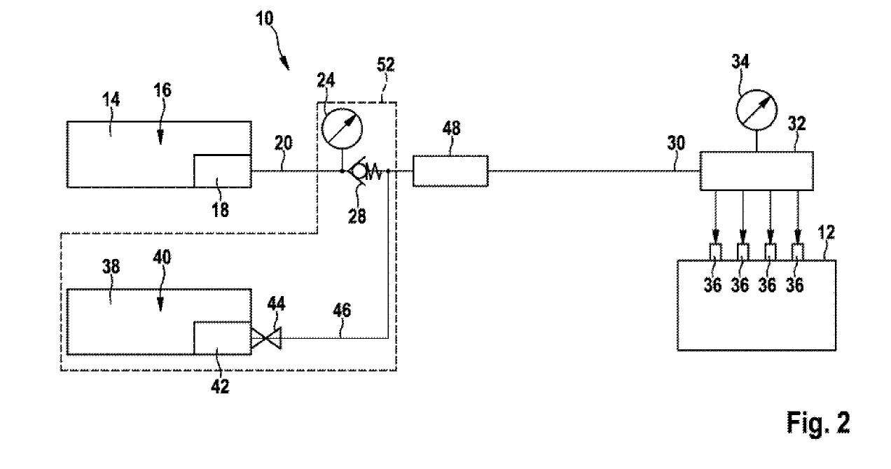

FIG. 2 shows the fuel system for the internal combustion engine in a second embodiment;

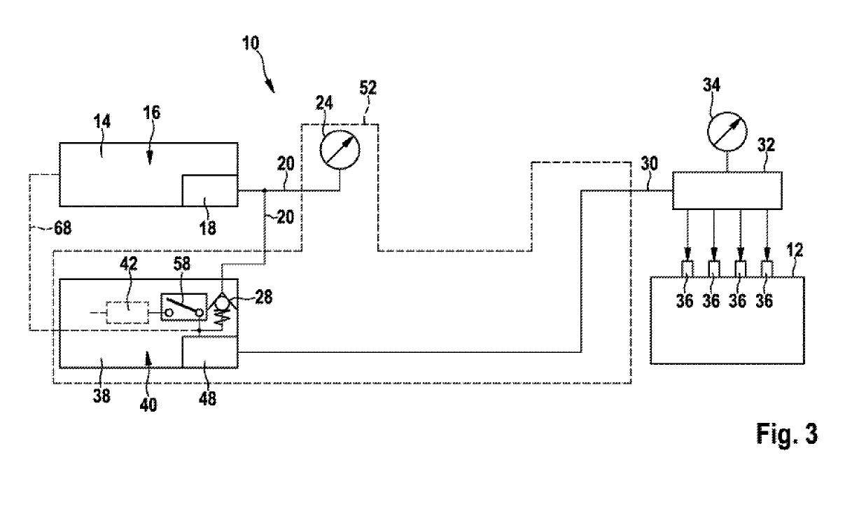

FIG. 3 shows the fuel system for the internal combustion engine in a third embodiment;

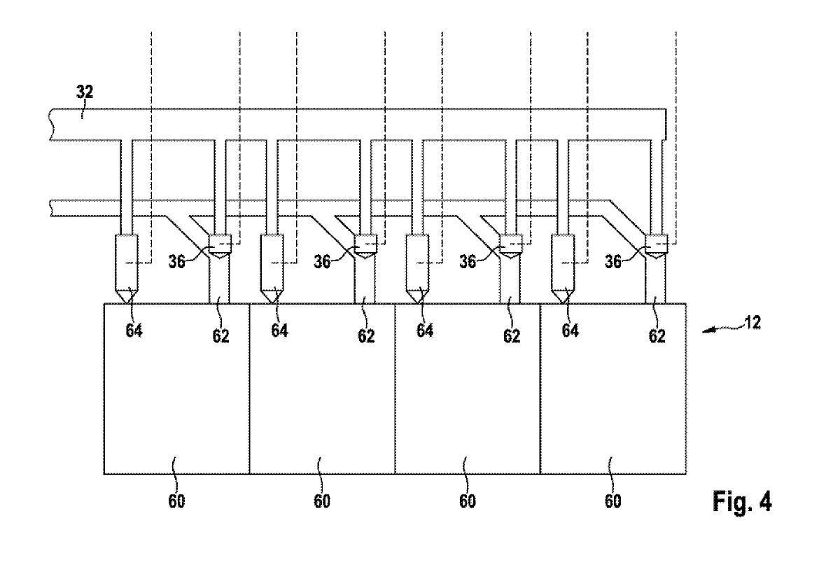

FIG. 4 shows an injection device of the internal combustion engine in a first embodiment; and

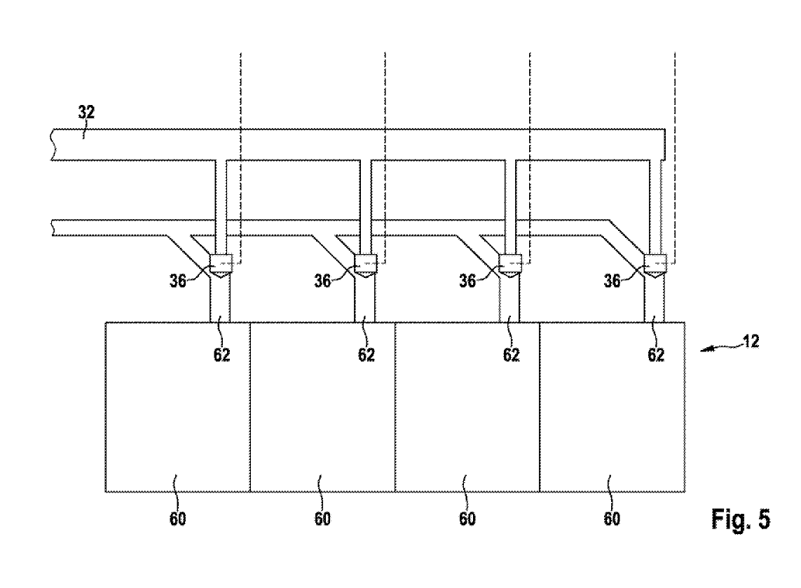

FIG. 5 shows the injection device of the internal combustion engine in a second embodiment.

The same reference symbols are used for functionally equivalent elements and variables in all the figures, even in different embodiments.

FIG. 1 shows a simplified illustration of a fuel system 10 for an internal combustion engine 12 in a first embodiment. In an upper, left-hand region in the drawing, a fuel container 14 for a first fuel type 16, which is gasoline here, is illustrated. A first electrically driven fuel pump 18 is arranged on or in the fuel container 14 and is hydraulically connected on the outlet side via a first low-pressure line 20 to the suction region of a high-pressure fuel pump 22 which is driven mechanically (for example by means of a camshaft of the internal combustion engine 12). A first pressure sensor 24 is arranged on the first low-pressure line 20. The mechanically driven high-pressure fuel pump 22 comprises a quantity control valve (not illustrated) for controlling the fuel quantity which is fed.

On the outlet side, the mechanically driven high-pressure fuel pump 22 is hydraulically connected to a non-return valve 28 via a first high-pressure line 26.

The non-return valve 28 can open in the feed direction. A second high-pressure line 30, which is connected to a fuel high-pressure accumulator 32 (“rail”), is arranged downstream of the non-return valve 28. A second pressure sensor 34, by means of which a current fuel pressure in the high-pressure accumulator 32 can be determined, is arranged on the high-pressure accumulator. The high-pressure accumulator 32 is hydraulically connected via fuel lines to, in this case, four injection valves 36 of the internal combustion engine 12.

In the lower, left-hand region in the drawing a fuel container 38 for a second fuel type 40 is illustrated, which fuel type 40 is liquefied petroleum gas in this case. A second electrically driven fuel pump 42 is arranged on or in the fuel container 38 and is hydraulically connected on the outlet side via a controllable check valve 44 and then via a second low-pressure line 46 to the suction region of an electrically driven high-pressure fuel pump 48. The electrically driven high-pressure fuel pump 48 is hydraulically connected on the outlet side to the second high-pressure line 30 via a third high-pressure line 50.

A dashed outline 52 encloses those elements of the fuel system 10 which are present additionally compared to a conventional fuel system with just one fuel type 16. Alternatively it is possible to integrate the electrically driven high-pressure fuel pump 48, in addition to the electrically driven fuel pump 42, into the fuel container 38.

In a first operating mode, the internal combustion engine 12 is operated with gasoline. For this purpose, the first electrically driven fuel pump 18 feeds gasoline from the fuel container 14 into the first low-pressure line 20, wherein a hydraulic pressure of the gasoline is increased to a first feed pressure - for example up to 10 bar. The first feed pressure is determined by means of the first pressure sensor 24. The quantity control valve (not shown) controls the fuel quantity which is fed to the mechanically driven high-pressure fuel pump 22. The mechanically driven high-pressure fuel pump 22 feeds the gasoline into the first high-pressure line 26 with a second feed pressure, when the following non-return valve 28 opens.

For example, the second feed pressure is up to 150 bar. Gasoline is therefore fed into the second high-pressure line 30 and then into the high-pressure accumulator 32. The second electrically driven fuel pump 42 and the electrically driven high-pressure fuel pump 48 do not operate and the check valve 44 is blocked.

In a second operating mode, the internal combustion engine 12 is operated with liquefied petroleum gas. For this purpose, the second electrically driven fuel pump feeds liquefied petroleum gas from the fuel container 38 into the second low-pressure line 46 through the check valve 44 which is now opened, where in a hydraulic pressure of the liquefied petroleum gas is increased to a first feed pressure. The fuel pressure in the second fuel container 38 is, for example, up to 21 bar. The electrically driven high-pressure fuel pump 48 feeds the liquefied petroleum gas into the third high-pressure line 50 with a second feed pressure and then into the high-pressure accumulator 32. For example, the second feed pressure is up to 70 bar. The first electrically driven fuel pump 18 and the mechanically driven high-pressure fuel pump 22 do not feed. The non-return valve 28 is blocked, with the result that mixing of the two fuel types 16 and 40 does not take place upstream of the non-return valve 28.

A feed quantity of the liquefied petroleum gas is controlled in accordance with a respective requirement of the internal combustion engine 12 in that an electrical power level of the second electrically driven fuel pump 42 and/or of the electrically driven high-pressure fuel pump 48 is controlled. In particular, the second electrically driven fuel pump 42 and the electrically driven high-pressure fuel pump 48 are arranged separately from the internal combustion engine 12, wherein thermal insulation from the internal combustion engine 12 is produced. Together with a respective sufficiently high first and second feed pressure it is ensured that a vapor pressure of the liquefied petroleum gas or of the gasoline in the fuel system 10 is not undershot. As a result, the liquefied petroleum gas also remains in a liquid state on the way from the fuel container 38 as far as the injection by means of the injection valves 36.

FIG. 2 shows a further simplified illustration of the fuel system 10 for the internal combustion engine 12 in a second embodiment. In the upper, left-hand region in the drawing, the fuel container 14 for the first fuel type 16 (gasoline) is in turn illustrated. The first electrically driven fuel pump 18, which feeds gasoline—for example with a feed pressure of up to 10 bar—into the first low-pressure line 20, is arranged on or in the fuel container 14. The first low-pressure line 20 is connected in FIG. 2 to a non-return valve 28 which can open in the feed direction. The non-return valve 28 is hydraulically connected downstream to the suction region of the electrically driven high-pressure fuel pump 48 which feeds fuel into the high-pressure accumulator 32 via the second high-pressure line 30.

In the lower, left-hand region in the drawing, the fuel container 38 for the second fuel type 40 (liquefied petroleum gas) is in turn illustrated. The second electrically driven fuel pump 42, which also has the check valve 44 on the outlet side, is arranged on or in the fuel container 38. A feed pressure of the second electrically driven fuel pump 42 is, for example, up to 21 bar. The check valve 44 is connected downstream to the second low-pressure line 46 which is also hydraulically connected to the suction region of the electrically driven high-pressure fuel pump 48. The electrically driven high-pressure fuel pump 48 feeds the gasoline or the liquefied petroleum gas into the high-pressure accumulator 32 via the second high-pressure line 30. The dashed outline 52 in turn encloses those elements of the fuel system 10 which are additionally present compared to a conventional fuel system with just one fuel type 16.

In the first operating mode (gasoline) of the internal combustion engine 12, the second electrically driven fuel pump 42 is switched off and the check valve 44 is blocked. The first electrically driven fuel pump 18 and the electrically driven high-pressure fuel pump 48, wherein the non-return valve 28 opens, feed. In this context, the feed pressure is, for example, up to 70 bar.

In the second operating mode (liquefied petroleum gas) of the internal combustion engine 12, the first electrically driven fuel pump 18, wherein the non-return valve 28 is blocked, is switched off. The check valve 44 is opened and the second electrically driven fuel pump 42 and the electrically driven high-pressure fuel pump 48 feed. In this context, the feed pressure is also, for example, up to 70 bar.

During operation of the fuel system 10, the respective feed pressure ensures, similarly to the case of the fuel system 10 in FIG. 1, that the vapor pressure of the liquefied petroleum gas or of the gasoline in the fuel system 10 is not undershot. Moreover, the electrically driven high-pressure fuel pump 48 is embodied in such a way that even during or after switching over from the liquefied petroleum gas mode to the gasoline mode, sufficient compression always takes place, which prevents the production of possible vapor bubbles. Also as in the fuel system 10 according to FIG. 1, the electrically driven fuel pumps 18 and 42 and the electrically driven high-pressure fuel pump 48 in FIG. 2 are arranged separately from the internal combustion engine 12. As a result, the respective fuel remains sufficiently cold as far as the injection by means of the injection valves 36. Furthermore, the electrically driven high-pressure fuel pump 48 permits a sufficient fuel pressure already to be present in the high-pressure accumulator 32 before or during the starting of the internal combustion engine 12, and no gas bubbles are therefore produced.

FIG. 3 shows a further simplified illustration of the fuel system 10 for the internal combustion engine 12 in a third embodiment. In the upper, left-hand region in the drawing, the fuel container 14 for the first fuel type 16 (gasoline) is in turn illustrated. The first electrically driven fuel pump 18, which feeds gasoline—for example with a pressure of up to 10 bar—into the first low-pressure line 20, is arranged on or in the fuel container 14. The first low-pressure line 20 is connected in FIG. 3 to a non-return valve 28 which can open in the feed direction and is arranged in this case on or in the second fuel container 38. The fuel pressure in the second fuel container 38 is, for example, up to 21 bar.

Furthermore, the electrically driven high-pressure fuel pump 48 and a check valve 58 are arranged in the second fuel container 38 in FIG. 3. On the inlet side, the switching valve 58 is connected to the stored liquefied petroleum gas and on the outlet side it is connected to the suction region of the electrically driven high-pressure fuel pump 48. Likewise, the non-return valve 28 is connected downstream to the suction region of the electrically driven high-pressure fuel pump 48. The electrically driven high-pressure fuel pump 48 feeds the respective fuel into the high-pressure accumulator 32 via the second high-pressure line 30. In this context, the feed pressure is, for example, up to 70 bar both in the gasoline mode and in the liquefied petroleum gas mode. The dashed outline 52 in turn encloses those elements of the fuel system 10 which are additionally present compared to a conventional fuel system with just one fuel type 16.

In addition, a hydraulic connection 68 (“gasoline return line”) is arranged between a suction region of the electrically driven high-pressure fuel pump 48 and the fuel container 14. Possible gas bubbles can be scavenged by the hydraulic connection 68 in the gasoline mode of the internal combustion engine 12, with the result that the gas bubbles are not fed by the electrically driven high-pressure fuel pump 48.

In the first operating mode of the internal combustion engine 12, gasoline is fed from the first fuel container 14 to the non-return valve 28 via the first low-pressure line 20 by means of the first electrically driven fuel pump 18, as a result of which said non-return valve 28 opens. The electrically driven high-pressure fuel pump 48 increases the hydraulic pressure of the gasoline up to 70 bar, when the gasoline is fed into the high-pressure accumulator 32 via the high-pressure line 30. The switching valve 58 is closed, with the result that mixing of the two fuel types does not take place.

In the second operating mode of the internal combustion engine 12, liquefied petroleum gas is fed from the second fuel container 38 into the high-pressure line 30 via the opened switching valve 58 and then into the high-pressure accumulator 32 by the electrically driven high-pressure fuel pump 48. The first electrically driven fuel pump 18 is switched off, as a result of which the non-return valve 28 blocks. As a result, mixing of the two fuel types does not take place.

Optionally, a or the second electrically driven fuel pump 42 can be arranged in the fuel container 38 in the fuel system 10 in FIG. 3, which fuel pump 42 feeds liquefied petroleum gas from the second fuel container 38 with a first feed pressure to the inlet of the switching valve 58. The second electrically driven fuel pump 42 is illustrated by dashed lines in the drawing.

FIG. 4 shows an injection device of the internal combustion engine 12 in a first embodiment. A liquefied petroleum gas intake manifold injection system in combination with a gasoline direct injection system is illustrated. The internal combustion engine 12 has four cylinders 60 in this case. Inlet valves (not illustrated) are connected to intake manifolds 62 which can suck in air from an air system (not shown either). The high-pressure accumulator 32 is connected to first injection valves 64 which can inject fuel directly into the cylinder 60. Furthermore, the high-pressure accumulator 32 is connected to second injection valves 36 which can inject fuel into the intake manifolds 62. The vertical dashed lines are electrical control lines (without reference symbols).

If the internal combustion engine 12 is operated with gasoline, the gasoline is injected directly into the cylinder 60 by means of the injection valves 64. The second injection valves 36 are blocked here. If the internal combustion engine 12 is operated with liquefied petroleum gas, the liquefied petroleum gas is injected into the intake manifolds 62 by means of the injection valves 36. The first injection valves 64 are blocked here.

FIG. 5 shows the injection device of the internal combustion engine 12 in a second embodiment, as an alternative to FIG. 4. A liquefied petroleum gas intake manifold injection system in combination with a gasoline intake manifold injection system is illustrated. In contrast to FIG. 4, the embodiment according to FIG. 5 does not have first injection valves 64. For both fuel types, the respective fuel is injected into the intake manifolds 62 by means of the second injection valves 36.

1. A fuel system for an internal combustion engine that is operable with at least two fuel types, comprising:
an electrically driven high-pressure fuel pump for configured to pump at least one of the at least two fuel types,
wherein the electrically driven high-pressure fuel pump is connected, on an outlet side, to a high-pressure line which is common to the at least two fuel types.

2. The fuel system of claim 1, wherein:
a first fuel type of the at least two fuel types is gasoline fuel, diesel fuel, or a fuel having a comparatively low vapor pressure; and
a second fuel type of the at least two fuel types is liquefied petroleum gas, or a fuel having a comparatively high vapor pressure.

3. The fuel system of claim 1, wherein the electrically driven high-pressure fuel pump is at least one of:
thermally insulated; and
positioned separately from the internal combustion engine.

4. The fuel system of claim 2, further comprising:
a mechanically driven high-pressure fuel pump configured to feed gasoline,
wherein the electrically driven high-pressure fuel pump is configured to feed liquefied petroleum gas, and
wherein the mechanically driven high-pressure fuel pump is connected, on an outlet side, to the high-pressure line.

5. The fuel system of claim 4, further comprising:
a first electrically driven fuel pump, configured to feed gasoline, that is positioned in a region of a gasoline fuel container, and that includes a pressure region that is connected to a suction region of the mechanically driven high-pressure fuel pump; and
a second electrically driven fuel pump, configured to feed liquefied petroleum gas, that is positioned in a region of a liquefied petroleum gas fuel container, and that includes a pressure region connected to a suction region of the electrically driven high-pressure fuel pump.

6. The fuel system of claim 5, further comprising:
a non-return valve configured to open in a feed direction and positioned in a pressure region of the mechanically driven high-pressure fuel pump; and
a check valve or a further non-return valve positioned in the pressure region of the second electrically driven fuel pump.

7. The fuel system of claim 2, wherein the electrically driven high-pressure fuel pump is connected, on an inlet side, to gasoline and liquefied petroleum gas.

8. The fuel system in of claim 7, further comprising:
a first electrically driven fuel pump, configured to feed gasoline, that is positioned in a region of a gasoline fuel container, wherein and that includes a pressure region connected to a suction region of the electrically driven high-pressure fuel pump; and
a second electrically driven fuel pump, configured to feed liquefied petroleum gas, that is positioned in a region of a liquefied petroleum gas fuel container, and that includes a pressure region connected to the suction region of the electrically driven high-pressure fuel pump.

9. The fuel system of claim 8, further comprising:
a non-return valve configured to open in a feed direction and positioned in the pressure region of the first electrically driven fuel pump; and
a check valve or a further non-return valve positioned in the pressure region of the second electrically driven fuel pump.

10. The fuel system of claim 7, further comprising:
an electrically driven fuel pump, configured to feed gasoline, that is positioned in a region of a fuel container, and that includes a pressure region that is connected to a suction region of the electrically driven high-pressure fuel pump
wherein the electrically driven high-pressure fuel pump is positioned in a region of a liquefied petroleum gas fuel container.

11. The fuel system of claim 10, further comprising:
a non-return valve configured to open in a feed direction and positioned in the pressure region of the electrically driven fuel pump,
wherein the liquefied petroleum gas fuel container is connected to the suction region of the electrically driven high-pressure fuel pump via a switching valve or a non-return valve.
